(19) United States
(12) Patent Application Publication
(10) Pub. No.: US 2013/0147676 A1
(43) Pub. Date: Jun. 13, 2013

(54) ANTENNA STRUCTURE AND ELECTRONIC DEVICE USING THE SAME

(71) Applicants: SHU-WEI CHANG, Tu-Cheng (TW); HSIN-HUNG LIU, Tu-Cheng (TW); FU-HSIUNG YANG, Tu-Cheng (TW)

(72) Inventors: SHU-WEI CHANG, Tu-Cheng (TW); HSIN-HUNG LIU, Tu-Cheng (TW); FU-HSIUNG YANG, Tu-Cheng (TW)

(73) Assignee: HON HAI PRECISION INDUSTRY CO., LTD., Tu-Cheng (TW)

(21) Appl. No.: 13/559,617

(22) Filed: Jul. 27, 2012

(30) Foreign Application Priority Data
Dec. 8, 2011 (TW) 100145209

(51) Int. Cl. H01Q 1/52

(52) U.S. Cl. 343/841

(57) ABSTRACT

An antenna structure includes a first antenna and a second antenna both connected to a PCB of an electronic device and a grounded metal sheet arranged between the first antenna and the second antenna. The metal sheet forms a capacitor and an inductor, and the capacitor and the inductor form a filtering circuit that is able to reduce interference between the first antenna and the second antenna.

### BACKGROUND

1. Technical Field

The present disclosure relates to an antenna structure and, particularly, to an antenna structure capable of reducing interference between two adjacent antennas.

2. Description of Related Art

Two or more antennas are provided in some electronic devices to enable the electronic device communicate with other electronic devices in different networks. However, if the electronic device includes two or more antennas, the two adjacent antennas may interfere with each other.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view of an electronic device in accordance with an exemplary embodiment.

FIG. 2 is a circuit diagram of a filtering circuit for a first antenna and a second antenna of an antenna structure of the electronic device of FIG. 1.

FIG. 3 is an interference analysis diagram between the first antenna and the second antenna of the antenna structure of FIG. 2 without a metal sheet between the first and second antennas.

FIG. 4 is an interference analysis diagram between the first antenna and the second antenna of the antenna structure of FIG. 2 with a metal sheet between the first and second antennas.

### DETAILED DESCRIPTION

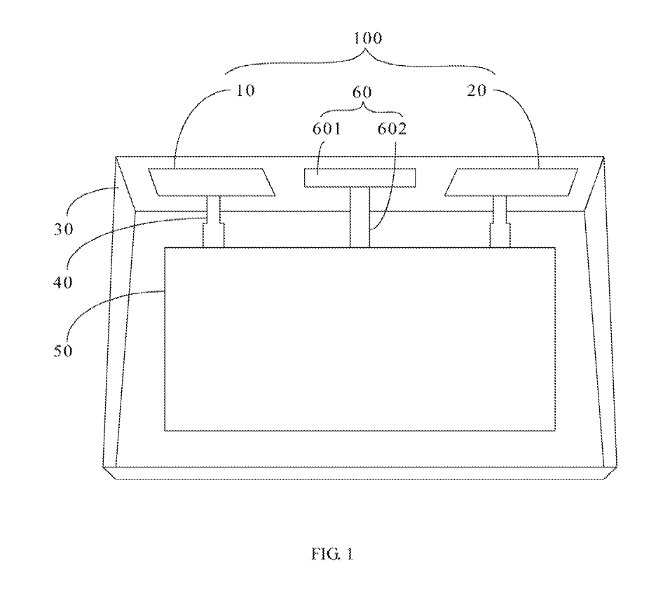

FIG. 1 is a schematic view of an electronic device 1 with an antenna structure 100. The antenna structure 100 includes a first antenna 10 and a second antenna 20. The first antenna 10 and the second antenna 20 are arranged on the inside wall of a housing 30 of the electronic device 1 and are each connected to their own feed-in point and ground point on a printed circuit board (PCB) 50 of the electronic device 1 through two components 40. In the embodiment, the first antenna 10 and the second antenna 20 are both flexible printed circuit (FPC) antennas, the housing 30 of the electronic device 1 is made of metal, and the component 40 is an elastic conductor.

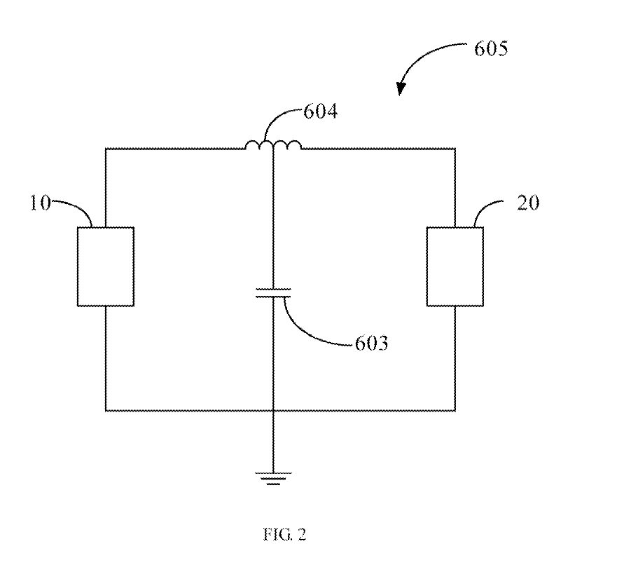

The first antenna 10 and the second antenna 20 are very close to each other and have the same ground, thus the first antenna 10 and the second antenna 20 emit strong interference to the other. In order to reduce the interference between the first antenna 10 and the second antenna 20, a T-shaped metal sheet 60 is arranged between the first antenna 10 and the second antenna 20. The metal sheet 60 includes a horizontal portion 601 and a vertical portion 602, and the vertical part 602 is connected to printed circuit board (PCB) 50 of the electronic device 1 for grounding. When electromagnetic signals interact with the metal sheet 60, the horizontal portion 601 will function as a capacitor (capacitor 603) and the vertical portion 602 will function as an inductor (inductor 604). The inductor 603 and the capacitor 604 form a filtering circuit 605, as shown in FIG. 2, which can very much reduce the interference between the first antenna 10 and the second antenna 20.

In the embodiment, the first antenna 10 is an FPC global positioning system (GPS) antenna whose frequency band is about 1.575 GHz, and the second antenna 20 is an FPC wireless fidelity (Wi-Fi) antenna whose frequency band is about 24 GHz-2.494 GHz. The T shaped metal sheet 60 is made of copper, in other embodiments the T shaped metal sheet 60 may be made of other suitable material, such as iron, aluminum, or silver.

In other embodiments, more than two antennas may be used, and there is one metal sheet 60 arranged between two adjacent antennas to reduce interference between the two antennas.

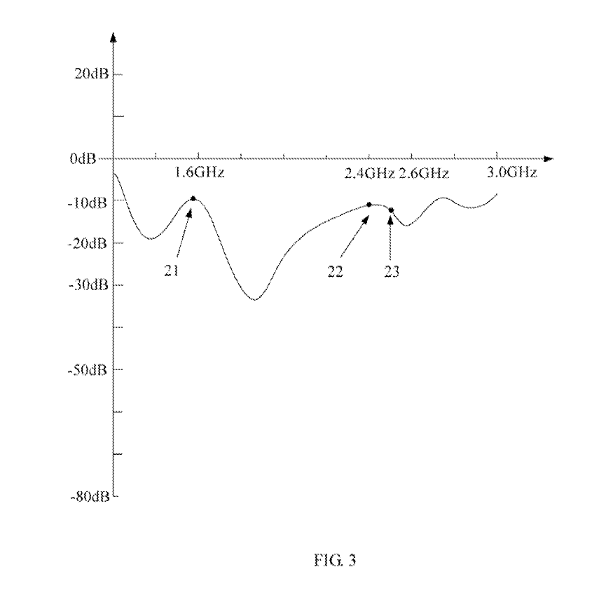

FIG. 3 is an interference analysis diagram between the first antenna 10 and the second antenna 20 when there is no T shaped metal 60 arranged between the first antenna 10 and the second antenna 20. As shown in the diagram, the isolation of the GPS signal designated as “21” is about −8.24 dB, and the isolation of the Wi-Fi signals designated as “22” and “23” are about −11.78 dB˜−13.50 dB.

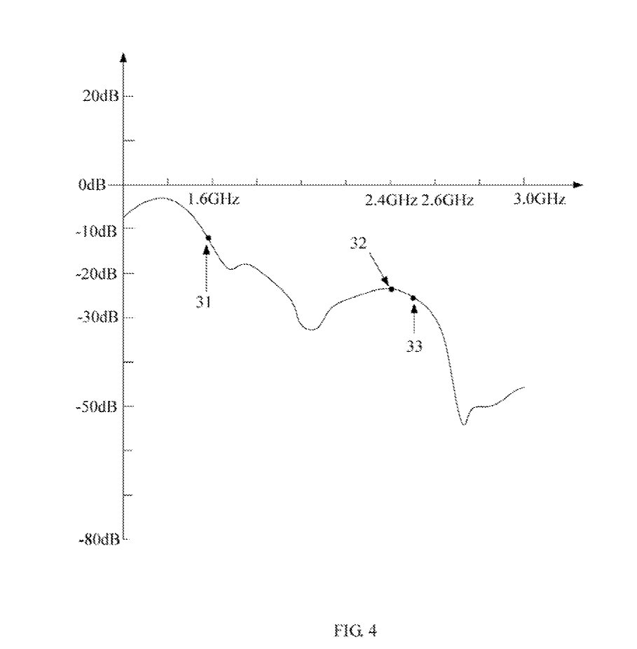

FIG. 4 is an interference analysis diagram between the first antenna 10 and the second antenna 20 when the T shaped metal 60 is arranged between the first antenna 10 and the second antenna 20. As shown in the diagram, the isolation of the GPS signal designated as “31” is about −14.98 dB, and the isolation of the Wi-Fi signals designated as “32” and “33” are about −22.92 dB and −24.78 dB. Clearly, the presence of the T shaped metal sheet 60 between the first antenna 10 and the second antenna 20 increases the isolation between the first antenna 10 and the second antenna 20 are both increased, and interference between the first antenna 10 and the second antenna 20 is reduced.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An antenna structure for use in a housing of an electronic device, the antenna structure comprising:
a first antenna and a second antenna both connected to a printed circuit board of the electronic device; and
a grounded metal sheet arranged between the first antenna and the second antenna, wherein the metal sheet forms a capacitor and an inductor, and the capacitor and the inductor form a filtering circuit that is able to reduce interference between the first antenna and the second antenna.

2. The antenna structure as described in claim 1, wherein the metal sheet is substantially T-shaped and comprises a vertical portion and a horizontal portion, the vertical portion is connected to the printed circuit board for grounding, when electromagnetic signals interact with the metal sheet, the horizontal portion functions as a capacitor and the vertical portion functions as an inductor.

3. The antenna structure as described in claim 2, wherein the metal sheet is made of copper.

4. The antenna structure as described in claim 1, wherein both of the first antenna and the second antenna are connected to the printed circuit board by two components, one of the two components is for feed-in and the other of the two components is for grounding.

5. The antenna structure as described in claim 4, wherein the two components are both elastic conductor.

6. The antenna structure as described in claim 1, wherein the first antenna and the second antenna are both flex printed circuit (FPC) antenna.

7. The antenna structure as described in claim 6, wherein the first antenna is a global positioning system (GPS) antenna and the second antenna is a wireless fidelity (Wi-Fi) antenna.

8. An electronic device comprising:
a housing;
a printed circuit board arranged in the housing;
a first antenna and a second antenna both connected to a printed circuit board; and
a grounded metal sheet arranged between the first antenna and the second antenna, wherein the metal sheet forms a capacitor and an inductor, and the capacitor and the inductor form a filtering circuit that is able to reduce interference between the first antenna and the second antenna.

9. The electronic device as described in claim 8, where wherein the metal sheet is substantially T-shaped and comprises a vertical portion and a horizontal portion, the vertical portion is connected to the printed circuit board for grounding, when electromagnetic signals interact with the metal sheet, the horizontal portion functions as a capacitor and the vertical portion functions as an inductor.

10. The electronic device as described in claim 8, wherein the metal sheet is made of copper.

11. The electronic device as described in claim 8, wherein both of the first antenna and the second antenna are connected to the printed circuit board by two components, one of the two components is for feed-in and the other of the two components is for grounding.

12. The electronic device as described in claim 11, wherein the two components are both elastic conductor.

13. The electronic device as described in claim 8, wherein the first antenna and the second antenna are both flex printed circuit (FPC) antenna.

14. The electronic device as described in claim 13, wherein the first antenna is a global positioning system (GPS) antenna and the second antenna is a wireless fidelity (Wi-Fi) antenna.
